(19) United States
(12) Patent Application Publication
(10) Pub. No.: US 2008/0029563 A1
(43) Pub. Date: Feb. 7, 2008

(54) Adapter system for roofrack carrier

(76) Inventor: Larry D. Malone, Cape Elizabeth, ME (US)

Correspondence Address: BOHAN, MATHERS & ASSOCIATES, LLC, PO BOX 17707, PORTLAND, ME, 04112-8707, US

(21) Appl. No.: 11/498,025

(22) Filed: Aug. 2, 2006

(51) Int. Cl. B60R 9/00

(52) U.S. Cl. 224/319

(57) ABSTRACT

Adapter system for quickly mounting a carrier on a vehicle roofrack. The adapter system has a crossbar adapter and an intermediate adapter that are fastened to each other about the roofrack crossbar and which may remain in place on the crossbar, with or without the carrier. The carrier adapter is fastened to the carrier and remains fastened to the carrier as long as the carrier is intended to be used. The intermediate adapter has a key slot and the carrier adapter a mating key. The carrier is mounted on the roofrack by sliding the key on the carrier adapter into the key slot on the intermediate adapter. A locking mechanism prevents unauthorized removal of the carrier adapter from the roofrack.

### BACKGROUND INFORMATION

1. Field of the Invention

The invention relates to the field of attachment systems. More particularly, the invention relates to attachment systems to secure carriers onto any one of a number of different types of roof racks, such as onto an automobile roof rack.

2. Description of the Prior Art

Applicant of the present application is also the inventor and applicant of U.S. patent application Ser. No. 11/159,582, filed on Jun. 23, 2005, the subject matter of which is herein fully incorporated by reference. As described in that application, specific types or makes of carriers are generally required to secure oversized or odd shaped gear, such as skis, bicycles, canoes, or kayaks, to the roof rack of a vehicle. It can be time-consuming and tedious to secure a carrier on a roof rack.

Most known systems for attaching a carrier to a roofrack are customized for a specific type or shape of roofrack crossbar. The crossbars of the roof racks provided by the various manufacturers are not standardized and vary in contour and dimension. For example, Yakima Products, Inc. manufactures a roof rack with round crossbars, Thule AB manufactures a roof rack with square crossbars, and Ford Motor Corporation and Nissan Motor Corporation manufacture roof racks of different dimensions with oval crossbars. In the above mentioned patent application Ser. No. 11/159,582, Applicant disclosed a universal attachment system that forms a crossbar cavity capable of accommodating a crossbar of rectangular, square, round, oval, or other contour. Thus, the disclosed attachment system provides a universal system that is mountable on the roof racks of many makes and manufacturers.

It is desirable to have a means of very quickly and easily securing a carrier to the roof rack and, ideally, of having such a means that will accommodate the shapes and sizes of various makes of roofracks. It is also desirable to have a means that will prevent unauthorized removal of the gear mounted on the roofrack.

What is needed, therefore, is an adapter system that will prepare the roof rack for quick and easy attachment of a carrier, regardless of the type of roof rack and contour of the roof rack crossbar. What is further needed is such a system that will provide an anti-theft means that will prevent the gear from being removed by unauthorized persons from the roof rack.

### BRIEF SUMMARY OF THE INVENTION

The invention is a roofrack carrier attachment system comprising a roofrack adapter, which includes a crossbar adapter and an intermediate adapter, and a carrier adapter. The crossbar adapter and the intermediate adapter together form a crossbar cavity that accommodates the crossbar of the roofrack. The crossbar adapter and the intermediate adapter are fastened together about the roofrack crossbar to form the roofrack adapter. Ideally, the universal attachment system disclosed in patent application Ser. No. 11/159,582 is used as the roofrack adapter, because it will accommodate the crossbars of most known roofracks, whether the contour be rectangular, square, round, oval, or other shape. It is understood, however, that the scope of the invention is not limited to the use of that universal attachment system. The roofrack adapter may comprise a crossbar adapter and an intermediate adapter that are adapted to fit a specific type or shape of crossbar.

The carrier adapter is attached to the bottom of a carrier. Examples of such carrier devices include, but are not limited to, carrier devices for bicycles, kayaks, surf boards, snowboards, skis, cargo, etc. The upper contour of the intermediate adapter has a key slot and the lower contour of the carrier adapter a key that mates with the key slot. To secure the carrier to the roofrack, the key of the carrier adapter, with carrier attached, is slidingly engaged in the key slot on the intermediate adapter.

Locking mechanisms may be provided on the roofrack attachment system. A locking mechanism may be provided, for example, to secure key of the carrier adapter in the key slot, so as to prevent the carrier adapter from shifting or sliding in the intermediate adapter during travel and/or to prevent unauthorized removal of the carrier from the roofrack. Alternatively, a separate locking mechanism may be provided to lock the carrier adapter against unauthorized removal of the carrier from the roofrack.

Once the roofrack adapter is mounted on the roofrack, it may remain there for an extended period of time, with or without a carrier mounted on it. Similarly, once the carrier adapter is attached to the carrier, it may remain there for as long as the carrier is intended to be used, whether or not it is actually being used. In this manner, the carrier is always ready to be mounted on the roofrack adapter, without having to first affix anything to the crossbars of the roofrack or to the carrier. Mounting a carrier to the roofrack now becomes a very simple task. The carrier adapter with carrier attached is simply slid into the intermediate adapter and secured with the locking mechanism. No tools are required, other than perhaps a key to lock the locking mechanism. A user who transports various types of gear at different times may have a single roofrack adapter with multiple carrier adapters, so that, for example, the kayak carrier, the bicycle carrier, and the canoe carrier are all ready to be mounted on the roofrack adapter or exchanged at a moment's notice.

The two components of the roofrack adapter may be constructed of any rugged and form-rigid material that is suitable for tightly clamping on to a bar, which is typically a metal bar. The carrier adapter does not have to provide a secure fit around a metal bar, so it may be constructed of the same material or of any other suitable material that will provide the necessary rigidity to form a key that will provide the smooth, yet tight fit with the corresponding key slot. Although the scope of the invention is not limited to a particular type of material, the roofrack and carrier adapters may constructed of a non-abrasive plastic, such as a polypropylene or a polycarbon plastic that has the strength and rigidity necessary to securely mount the components to the roofrack and the carrier, respectively and to securely retain the carrier adapter in the key slot of the intermediate adapter, even under stress conditions resulting from a moving vehicle. The fasteners are ideally constructed of non-corroding stainless steel.

### BRIEF DESCRIPTION OF THE DRAWINGS

The present invention is described with reference to the accompanying drawings. In the drawings, like reference numbers indicate identical or functionally similar elements.

FIG. 1 illustrates the assembled universal carrier attachment system according to the invention.

FIG. 2 is a frontal plane view of the crossbar adapter.

FIG. 3 is a frontal plane view of the intermediate adapter.

FIG. 4 is a top plane view of the intermediate adapter.

FIG. 5 is a frontal plane view of the carrier adapter.

FIG. 6 shows the crossbar adapter and intermediate adapter assembled together.

FIG. 7 shows the carrier adapter attached to the carrier.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

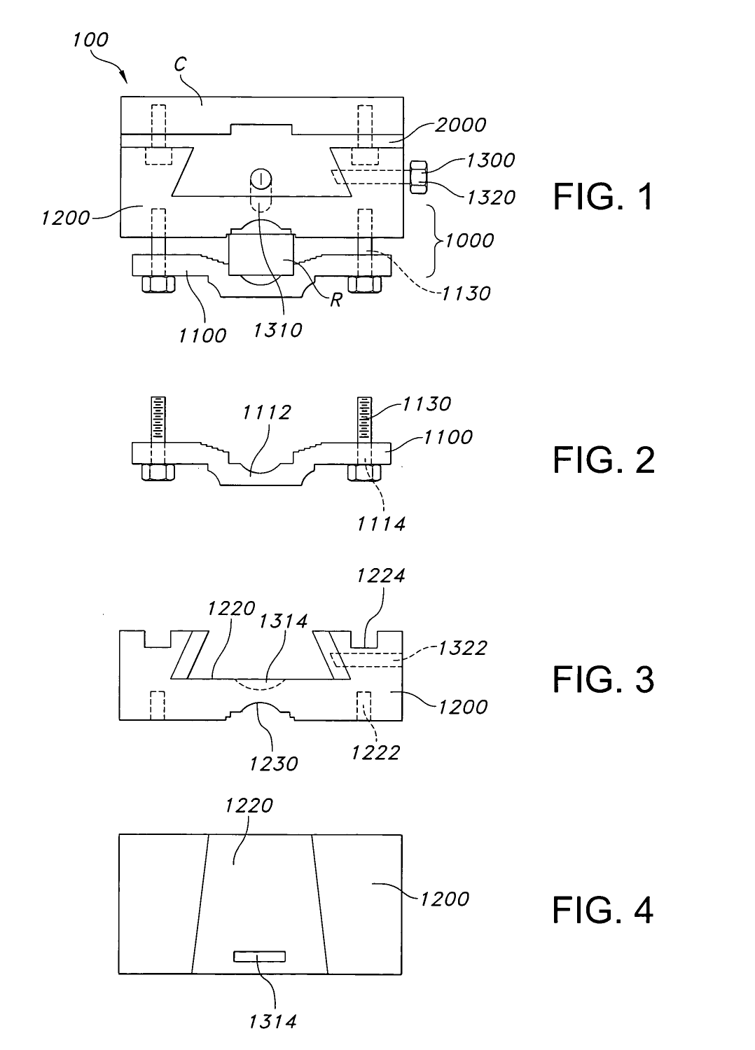

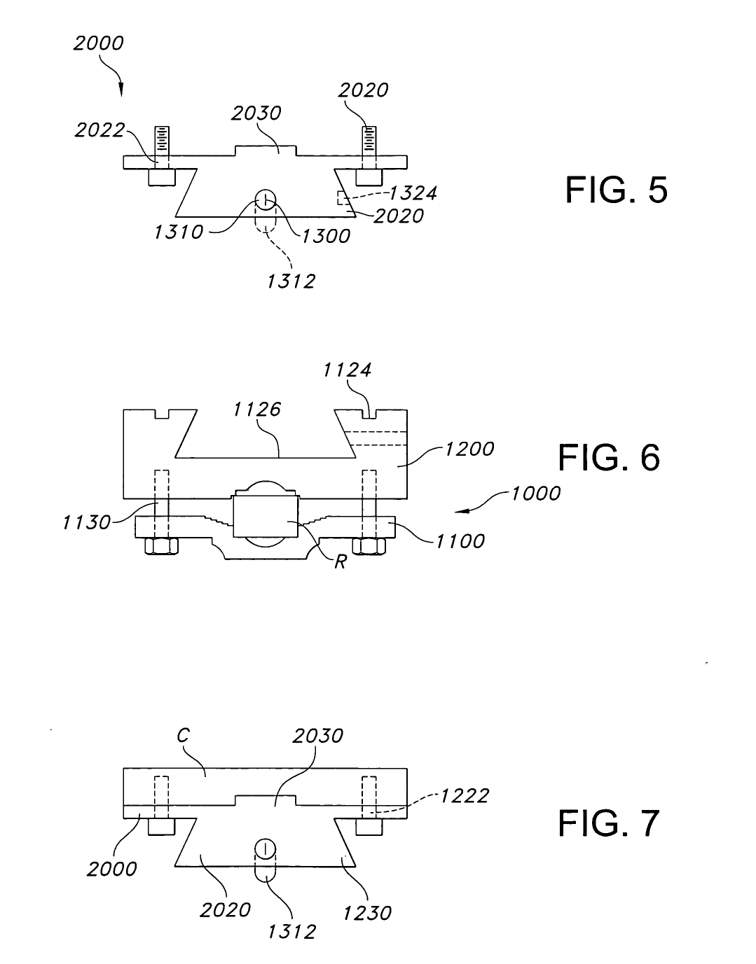

FIG. 1 illustrates a roofrack carrier attachment system 100 comprising a roofrack adapter 1000, which includes a crossbar adapter 1100 and an intermediate adapter 1200, and a carrier adapter 2000. Detail drawings of the various components of the roofrack carrier attachment system 100 are shown in FIGS. 2-7.

The crossbar adapter 1100 and the intermediate adapter 1200 are fastened together by a first fastener means 1130, as shown in FIG. 6. The crossbar adapter 1100 has a contour 1112 and the intermediate adapter 1200 a contour 1230 for accommodating a roofrack crossbar R. In the embodiment shown, the contours 1112 and 1230 are universal contours that are adapted to accommodate most types of known roofrack crossbars. In other embodiments, the contours may be adapted to fit a specific type or shape of a roofrack crossbar. The first fastener means 1130 for fastening the crossbar adapter 1100 to the intermediate adapter 1200 is ideally a threaded fastener. Through bores 1114 are provided in the crossbar adapter and threaded bores 1222 in the intermediate adapter 1200 for receiving the threaded fastener. The length of the first fastener means 1130 is selected to accommodate the thickness of the roofrack crossbar R.

The carrier adapter 2000 is attachable to a conventional carrier C, such as a kayak carrier, bicycle carrier, etc. by means of a second fastener means 2020. Preferably, the second fastener means 2020 is a threaded fastener. Through bores 2022 are provided in the carrier adapter 2000 for receiving a threaded fastener that is threaded into threaded bores provided in the carrier C. The carrier adapter 2000 has a key 2030 and the intermediate adapter 1200 a mating key slot 1220. The carrier adapter 2000 is mounted in the roofrack adapter 1000 by slidingly engaging the key 2030 in the key slot 1220. The key 2030 and key slot 1220 may be tapered in a horizontal direction in order to allow insertion of the key 2030 into the slot 1220 in one direction only. A tapered key slot is shown in FIG. 4. The mating key 2030 is correspondingly tapered to fit into the key slot.

One or more locking mechanisms 1300 may be provided on the roofrack carrier attachment system 100. A spring-biased locking pin 1320 is shown in FIG. 1. The pin is inserted through a through bore 1322 in the intermediate adapter 1200, such that a forward end of the locking pin 1320 reaches into a blind bore 1324 in the carrier adapter 2000. This prevents the carrier adapter 2000 from working its way out of the key slot 1220. Alternatively, a locking mechanism 1310 may be provided on the carrier adapter 2000. This mechanism allows a locking bar 1312 to be swung down into a recess 1314 provided on the intermediate adapter 1200, thereby locking the carrier adapter 2000 to the roofrack adapter 1000.

The shape of the carrer C shown herein is not intended to be limiting in any way to the scope of the invention. Rather, it is understood that the carrier C shown in the illustrations is representative of any type of roofrack carrier, and that the shape and size of such carriers varies widely, depending on the type of gear or equipment they are designed to secure.

It is understood that the embodiments described herein are merely illustrative of the present invention. Variations in the construction of the roofrack carrier attachment system may be contemplated by one skilled in the art without limiting the intended scope of the invention herein disclosed and as defined by the following claims.

What is claimed is:

1. An adapter system for a roofrack and carrier, the system comprising:
a roofrack adapter having a key slot; and
a carrier adapter having a key, wherein said roofrack adapter is fastenable about a roofrack crossbar by a first fastener and said carrier adapter is fastenable to a carrier; and wherein said carrier adapter is mounted onto said roofrack adapter by sliding said key into said key slot.

2. The adapter system of claim 1, further comprising a locking mechanism for locking said carrier adapter to said roofrack adapter.

3. The adapter system of claim 1, wherein said roofrack adapter has a first contour and a second contour that are adapted to fit securely about said roofrack crossbar.

4. The adapter system of claim 3, wherein said roofrack adapter comprises a crossbar adapter that includes said first contour and an intermediate adapter that includes said second contour.
